(19) United States
(12) Patent Application Publication
(10) Pub. No.: US 2026/0313172 A1
(43) Pub. Date: Oct. 8, 2026

(54) LIVE-STREAMING PROCESSING METHOD AND APPARATUS, AND DEVICE AND STORAGE MEDIUM

(71) Applicant: Beijing Youzhuju Network Technology Co., Ltd., Beijing (CN)

(72) Inventors: Qiang Fu, Beijing (CN); Liya Li, Beijing (CN); Jiali Hu, Beijing (CN); Zhiyao Xie, Beijing (CN); Jiemin Hu, Beijing (CN)

(21) Appl. No.: 19/484,854

(22) PCT Filed: Jun. 5, 2024
(86) PCT No.: PCT/CN2024/097583

§ 371 Date: Nov. 14, 2025

(30) Foreign Application Priority Data
Jun. 28, 2023 (CN) 202310781015.5

(51) Int. Cl. H04N 21/2187; H04N 21/431; H04N 21/472; H04N 21/478

(52) U.S. Cl. CPC H04N 21/2187; H04N 21/4316; H04N 21/472; H04N 21/47815

(57) ABSTRACT

The present disclosure provides a live streaming processing method, apparatus, and device, and a storage medium. The method includes: first, displaying at least one live streaming object on a live streaming object page, where the at least one live streaming object is individually provided with a corresponding object management control; and then, displaying a management function list on the live streaming object page in response to a trigger operation for a target object management control, where at least one management function control is displayed in the management function list, and the management function control is configured to trigger an execution of a corresponding management operation on a live streaming object corresponding to the target object management control.

### CROSS-REFERENCE TO RELATED APPLICATION(S)

The present application claims priority to Chinese Patent Application No. 202310781015.5, filed on Jun. 28, 2023, and entitled “LIVE-STREAMING PROCESSING METHOD AND APPARATUS, AND DEVICE, AND STORAGE MEDIUM”, which is incorporated herein by reference in its entirety.

### FIELD

The present disclosure relates to the field of data processing, and in particular, to a live streaming processing method, apparatus, and device, and a storage medium.

### BACKGROUND

With the development of Internet technology, live streaming has been widely used in a variety of applications.

Listed products can be managed before and during live streaming. The management operations include pinning a product to the top, adding a product, etc. However, currently, the process for a live streamer to perform product management involves a lengthy operation path, requiring a plurality of page redirections to trigger a single product management operation. Because it takes a long time to trigger product management, the live streaming experience of the live streamer may be affected.

### SUMMARY

To resolve the above technical problem, embodiments of the present disclosure provide a live streaming processing method.

According to a first aspect, the present disclosure provides a live streaming processing method. The method includes:
displaying at least one live streaming object on a live streaming object page, where the at least one live streaming object is individually provided with a corresponding object management control; and
displaying a management function list on the live streaming object page in response to a trigger operation for a target object management control, where at least one management function control is displayed in the management function list, and the management function control is configured to trigger an execution of a corresponding management operation on a live streaming object corresponding to the target object management control.

In an optional implementation, before displaying the at least one live streaming object on the live streaming object page, the method further includes:
displaying the live streaming object page on a live streaming room page in response to a preset trigger operation performed on the live streaming room page, where the live streaming room page is configured to display a live streaming image, and a display area of the live streaming room page is greater than a display area of the live streaming object page.

In an optional implementation, an object addition control is provided on the live streaming object page, and the method further includes:
displaying an object addition page on the live streaming room page in response to a trigger operation for the object addition control, where a plurality of candidate live streaming objects are displayed on the object addition page, the plurality of candidate live streaming objects belong to a set of candidate live streaming objects corresponding to the live streaming room page, and a display area of the object addition page is less than the display area of the live streaming room page.

In an optional implementation, the plurality of candidate live streaming objects are individually provided with an addition management control, and after displaying the object addition page on the live streaming room page in response to the trigger operation for the object addition control, the method further includes:
determining a candidate live streaming object corresponding to a target addition management control on the object addition page as a live streaming object on the live streaming object page in response to a preset trigger operation for the target addition management control.

In an optional implementation, at least one sorting tag is provided on the live streaming object page, and the method further includes:
sorting live streaming objects on the live streaming object page based on sorting indicator data corresponding to a target sorting tag of the at least one sorting tag, in response to a trigger operation for the target sorting tag, to obtain a list of sorted live streaming objects, where the sorting indicator data is determined based on interaction data of the live streaming objects in a current live streaming room; and
updating a display order of the live streaming objects on the live streaming object page based on the list of sorted live streaming objects.

In an optional implementation, an object settings control is provided on the live streaming object page, and the method further includes:
displaying an object settings page on the live streaming room page in response to a trigger operation for the object settings control, where the object settings page is configured to perform a setting operation on the live streaming object on the live streaming object page, and a display area of the object settings page is less than the display area of the live streaming room page.

In an optional implementation, live streaming operational data on a plurality of statistical dimensions is displayed in a live streaming data display region of the live streaming object page, and the live streaming operational data is used to reflect a live streaming operational status of a current live streaming room.

In an optional implementation, the method is applied to a live streamer client.

According to a second aspect, the present disclosure provides a live streaming processing apparatus. The apparatus includes:
a first display module configured to display at least one live streaming object on a live streaming object page, where the at least one live streaming object is individually provided with a corresponding object management control; and
a second display module configured to display a management function list on the live streaming object page in response to a trigger operation for a target object management control, where at least one management function control is displayed in the management function list, and the management function control is configured to trigger an execution of a corresponding management operation on a live streaming object corresponding to the target object management control.

According to a third aspect, the present disclosure provides a computer-readable storage medium, where the computer-readable storage medium stores instructions thereon, and the instructions, when executed on a terminal device, cause the terminal device to implement the method described above.

According to a fourth aspect, the present disclosure provides a live streaming processing device. The device includes: a memory, a processor, and a computer program stored on the memory and executable by the processor, where the processor, when executes the computer program, implements the method described above.

According to a fifth aspect, the present disclosure provides a computer program product. The computer program product includes a computer program/instruction. The computer program/instruction, when executed by a processor, implements the method described above.

Compared to the prior art, the technical solutions provided in the embodiments of the present disclosure have at least the following advantages.

Embodiments of the present disclosure provide a live streaming processing method, apparatus, and device, and a storage medium. The method includes: first, displaying at least one live streaming object on a live streaming object page, where the at least one live streaming object is individually provided with a corresponding object management control; and then, displaying a management function list on the live streaming object page in response to a trigger operation for a target object management control, where at least one management function control is displayed in the management function list, and the management function control is configured to trigger the execution of a corresponding management operation on a live streaming object corresponding to the target object management control.

### BRIEF DESCRIPTION OF THE DRAWINGS

The accompanying drawings are incorporated in this specification and constitute a part of this specification, show embodiments conforming to the present disclosure, and are used together with this specification to explain the principle of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a flowchart of a live streaming processing method according to an embodiment of the present disclosure;

FIG. 2a is a schematic diagram of a live streaming object page according to an embodiment of the present disclosure;

FIG. 2b is a schematic diagram of another live streaming object page according to an embodiment of the present disclosure;

FIG. 3 is a schematic diagram of a management function list according to an embodiment of the present disclosure;

FIG. 4 is a schematic diagram of an object addition page according to an embodiment of the present disclosure;

FIG. 5 is a schematic diagram of an object settings page according to an embodiment of the present disclosure;

FIG. 6 is a schematic structural diagram of a live streaming processing apparatus according to an embodiment of the present disclosure; and

FIG. 7 is a schematic structural diagram of a live streaming processing device according to an embodiment of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in this specification are only some rather than all of the embodiments of the present disclosure.

In order to shorten a product management path and diversify functions related to live streaming in applications, the embodiments of the present disclosure provide a live streaming processing method. The method includes: first, displaying at least one live streaming object on a live streaming object page, where each live streaming object is provided with a corresponding object management control; and then, displaying a management function list on the live streaming object page in response to a trigger operation for a target object management control, where at least one management function control is displayed on the management function list, and the management function control is configured to trigger the execution of a corresponding management operation on a live streaming object corresponding to the target object management control. It can be learned that, according to the embodiments of the present disclosure, the display of the management function list for the live streaming object is triggered through the object management control for the live streaming object on the live streaming object page, and the management operation is performed on the live streaming object based on the object management control in the management function list, so that convenient management of the live streaming object is implemented, an operating path is shortened, and the live streaming experience of a user hosting a live stream is improved.

Based on this, an embodiment of the present disclosure provides a live streaming processing method. FIG. 1 is a flowchart of a live streaming processing method according to an embodiment of the present disclosure. The method includes the following steps.

S101: Display at least one live streaming object on a live streaming object page, where the at least one live streaming object is individually provided with a corresponding object management control.

The live streaming processing method provided in this embodiment of the present disclosure is applied to a client, and may be specifically applied to a live streamer side client. For example, the live streamer side client may include a live streamer side client deployed on a smartphone, a live streamer side client deployed on a tablet computer, etc.

The live streaming object page, which is a page for displaying a live streaming object, may be a page whose display is triggered by tapping a shopping cart control before or during live streaming. The live streaming object displayed on the live streaming object page may be an object on which a user watching a live stream performs operations such as placing an order in a live streaming room, or an object on which a user hosting a live stream performs operations such as demonstration in a live streaming room.

The live streaming object displayed on the live streaming object page may be from a set of candidate live streaming objects of a current live streaming account. That is, a live streaming object from the set of candidate live streaming objects of the current live streaming account is added to a current live streaming room, and the added live streaming object is displayed on the live streaming object page. The set of candidate live streaming objects is a set of objects displayed on a candidate live streaming object aggregation page of a live streaming account corresponding to a live streaming room page. The candidate live streaming object is an object in a display window or a store corresponding to the live streaming account. After the user hosting the live stream adds the object in the display window or the store corresponding to the live streaming account to the live streaming object page, the candidate live streaming object may change to the live streaming object.

In this embodiment of the present disclosure, at least one live streaming object is displayed on the live streaming object page. The live streaming object may be an object such as an item or a service listed in the current live streaming room. For example, the object may be items such as snacks, clothes, appliances, etc. For another example, the object may be services such as admission tickets, movie tickets, etc. The at least one live streaming object is individually provided with a corresponding object management control for triggering the execution of a corresponding management operation on a live streaming object corresponding to a target object management control.

Each live streaming object is provided with a corresponding object management control. The object management control is an entry for quick management of the live streaming object corresponding to the object management control. The execution of a management operation on the live streaming object corresponding to the object management control can be triggered by tapping the object management control. The object management control may be provided at the corresponding live streaming object, forming a correspondence with the live streaming object.

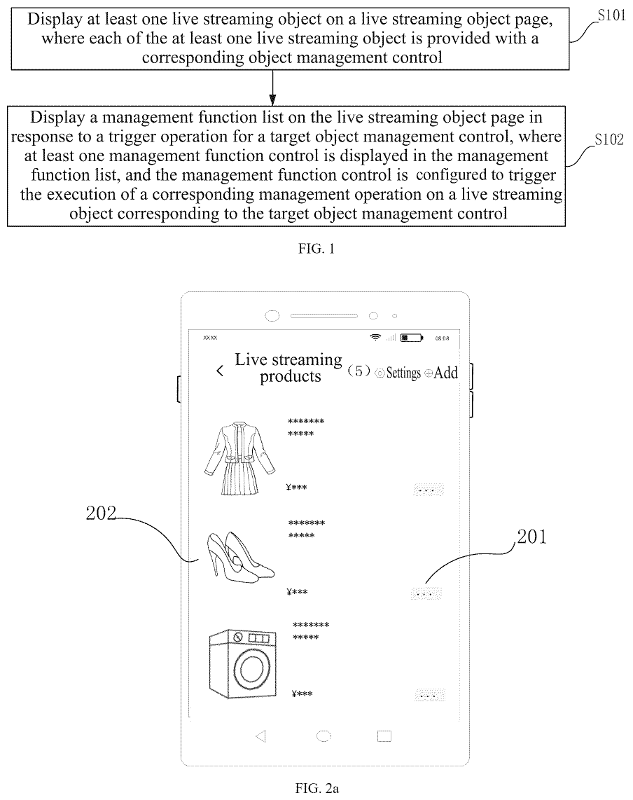

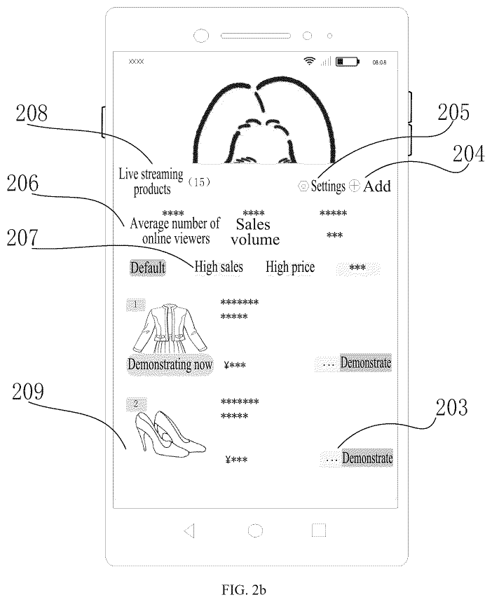

FIG. 2a is a schematic diagram of a live streaming object page according to an embodiment of the present disclosure. A live streaming object page 208 is displayed on a live streaming room page, and a live streaming object 202 on the live streaming object page 208 is provided with an object management control 201. That is, there is a correspondence between the object management control 201 and the live streaming object 202. The object management control 201 is configured to trigger the execution of a management operation on the live streaming object 202.

In actual application, the live streaming processing method provided in this embodiment of the present disclosure may be a method for managing live streaming objects before live streaming, or may be a method for managing live streaming objects during live streaming.

In a scenario of managing live streaming objects before live streaming, a management operation is performed on a live streaming object on a live streaming object page by triggering an object management control for the live streaming object. FIG. 2a shows a live streaming object page before live streaming, in which the object management control 201 corresponds to the live streaming object 202. FIG. 2b shows a live streaming object page during live streaming, in which each live streaming object is provided with a corresponding object management control.

If the management operation on the live streaming object is triggered during live streaming, there may be an interruption of a live video stream, which may in turn cause a live streaming interruption on the side of the user watching the live stream. For example, “The live streamer is temporarily away, please wait” is displayed on the screen, affecting the viewing experience of the user watching the live stream. Therefore, in this embodiment of the present disclosure, when a preset trigger operation performed on the live streaming room page is received, the live streaming object page is displayed on the live streaming room page, where a display area of the live streaming object page is less than a display area of the live streaming room page, thereby avoiding the interruption of the live video stream caused by the display of the live streaming object page, and reducing impact on the viewing experience of the user watching the live stream.

In an optional implementation, the live streaming object page may be displayed on the live streaming room page in the form of a half screen, a seven-tenths screen, or the like, to ensure that the display area of the live streaming object page is less than the display area of the live streaming room page, thereby avoiding the interruption of the live video stream caused by the full-screen display of the live streaming object page, and reducing impact on the live streaming.

In this embodiment of the present disclosure, when the preset trigger operation performed on the live streaming room page is received, the live streaming object page is displayed on the live streaming room page in the form of a half screen, a seven-tenths screen, or the like. In this case, because the display area of the live streaming room page is greater than the display area of the live streaming object page, the display of the live video stream is not affected during the display of the live streaming object page, and there is no need to interrupt the live video stream. Specifically, the live streaming object and the object management control that are in a correspondence are displayed on the live streaming object page.

FIG. 2b is a schematic diagram of another live streaming object page according to an embodiment of the present disclosure. During live streaming, in response to a trigger operation for a shopping cart control on a live streaming room page, a live streaming object page, such as a live streaming object page 201 shown in FIG. 2b, is displayed, with a display area less than full screen, on the live streaming room page. A plurality of live streaming objects, including a live streaming object 209, are displayed on the live streaming object page 201, and each live streaming object is provided with a corresponding object management control. The live streaming object 209 is provided with a corresponding object management control 203 for triggering the execution of a management operation on the live streaming object 209.

S102: Display a management function list on the live streaming object page in response to a trigger operation for a target object management control.

At least one management function control is displayed in the management function list, and the management function control is configured to trigger the execution of a corresponding management operation on a live streaming object corresponding to the target object management control.

In this embodiment of the present disclosure, the target object management control may be an object management control corresponding to any live streaming object displayed on the live streaming object page.

In this embodiment of the present disclosure, the management function control in the management function list may include, for example, a pin-to-top function control, a delete function control, a flash sales setting function control, etc. The management function control is configured to trigger the execution of a corresponding management operation on the live streaming object, where the management operation may be a live streaming-related setting operation for the live streaming object. Assuming that the target management function control is the pin-to-top function control, when the pin-to-top function control is tapped, the corresponding live streaming object is pinned to the top on the live streaming object page. Assuming that the target management function control is the delete function control, when the delete function control is tapped, the deletion of the corresponding live streaming object from the live streaming object page is triggered, which may also be referred to as “delisting”.

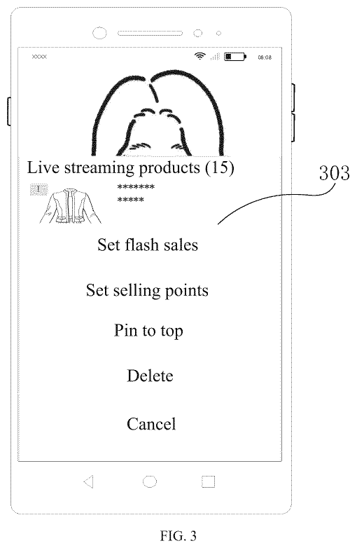

FIG. 3 is a schematic diagram of a management function list according to an embodiment of the present disclosure. When a trigger operation for the object management control 203 corresponding to the live streaming object 209 shown in FIG. 2b is received, a management function list 303 is displayed on the live streaming object page 201. A plurality of management function controls are displayed in the management function list 303. Specifically, the plurality of management function controls displayed in the management function list 303 may be those pre-selected by the user hosting the live stream from a set of management function controls, or may be those used frequently in the set of management function controls, etc.

In an optional implementation, the object management control may be displayed on the live streaming object page, to trigger the execution of the corresponding management operation on the corresponding live streaming object. In addition, an object addition control may further be displayed on the live streaming object page, where the object addition control is configured to trigger the addition of the live streaming object to the live streaming object page.

Quick addition of the live streaming object can be implemented through the object addition control on the live streaming object page, thereby improving the product addition experience of the user hosting the live stream during live streaming.

In an optional implementation, the object addition control is provided on the live streaming object page, and an object addition page is displayed on the live streaming room page when a trigger operation for the object addition control is received. A plurality of candidate live streaming objects are displayed on the object addition page. The plurality of candidate live streaming objects belong to the set of candidate live streaming objects of the live streaming account corresponding to the live streaming room page, where the set of candidate live streaming objects is a set of objects displayed on the candidate live streaming object aggregation page of the live streaming account corresponding to the live streaming room page. For example, the candidate live streaming object is a candidate live streaming object in the display window of the live streaming account corresponding to the live streaming room page.

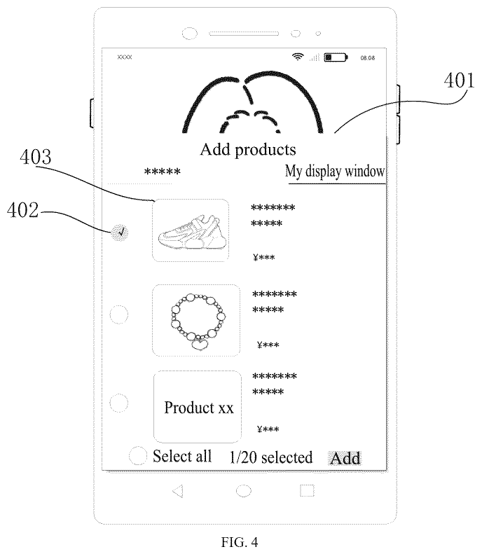

In order to avoid the interruption of the live video stream, the object addition page may be displayed, with a display area less than full screen, on the live streaming room page. FIG. 4 is a schematic diagram of an object addition page according to an embodiment of the present disclosure. When a trigger operation for the object addition control 204 in FIG. 2b is received, an object addition page 401 is displayed on the live streaming object page. A plurality of candidate live streaming objects are displayed on the object addition page. The plurality of candidate live streaming objects are individually provided with an addition management control. When a preset trigger operation for a target addition management control 402 on the object addition page is received, a candidate live streaming object corresponding to the target addition management control 402 is determined as the live streaming object on the live streaming object page, and then a product addition operation during live streaming is completed. In this embodiment of the present disclosure, a plurality of live streaming objects may be simultaneously added to the live streaming object page. Therefore, the target addition management control may include a plurality of addition management controls.

As shown in FIG. 4, when the trigger operation for the addition management control 402 is received, a candidate live streaming object 403 corresponding to the addition management control 402 is determined as the live streaming object on the live streaming object page, and a redirection to the live streaming object page is performed, to display the currently added live streaming object 403 on the live streaming object page.

In order to enable the user hosting the live stream to adjust a live streaming strategy in a timely manner during the live streaming based on a live streaming status of the live streaming object, and thus improving the viewing experience of the user watching the live stream, in this embodiment of the present disclosure, live streaming objects may be sorted based on sorting indicator data that is determined based on interaction data of the live streaming objects in a current live streaming room, and a list of sorted live streaming objects is displayed on the live streaming object page, so that the user hosting the live stream can adjust the live streaming strategy in a timely manner based on the list of sorted live streaming objects.

In this embodiment of the present disclosure, at least one sorting tag, for example, a sorting tag 207 “High sales” in FIG. 2b, is provided on the live streaming object page. When a trigger operation for a target sorting tag of the at least one sorting tag is received, the respective live streaming objects on the live streaming object page are sorted based on sorting indicator data corresponding to the target sorting tag, to obtain a list of sorted live streaming objects. The sorting indicator data is determined based on interaction data of the respective live streaming objects in a current live streaming room. Then, a display order of the live streaming objects on the live streaming object page is updated based on the list of sorted live streaming objects.

Sorting tags on the live streaming object page may include indicator tags that can represent interaction data of the live streaming object in the current live streaming room, such as a high-price tag, a high-sales tag, and a high-price-performance-ratio tag. For example, sorting of the live streaming objects based on sales quantities of the live streaming objects in the current live streaming room, etc. may be triggered by tapping the high-sales tag.

In an optional implementation, live streaming objects in the current live streaming room can be sorted again by triggering different sorting tags, and live streaming object lists displayed after the live streaming objects are sorted based on different sorting tags are separately displayed on the live streaming object page. Because the sorting indicator data is based on interaction data of the live streaming objects in the current live streaming room, and the interaction data constantly changes, sequences of live streaming objects in live streaming object lists obtained at different moments may be different.

The sorting tag is provided on the live streaming object page, so that the user hosting the live stream can more intuitively and clearly learn of a live streaming status of each live streaming object during live streaming, thereby helping the live streamer adjust the live streaming strategy in a timely manner.

In addition, an object settings control, such as an object settings control 205 in FIG. 2b, may further be provided on the live streaming object page. In actual application, if a setting operation is performed on the live streaming object, the object settings control needs to be tapped, to trigger the full-screen display of an object settings page. If a current state is a live streaming state, live streaming may be affected. Therefore, in this embodiment of the present disclosure, the object settings page is displayed, with a display area less than full screen, on the live streaming room page, in response to a trigger operation for the object settings control. The object settings page is configured to perform the setting operation on the live streaming object on the live streaming object page.

In an optional implementation, when the trigger operation for the object settings control is received, in order to avoid the interruption of the live video stream, the object settings page is displayed, with a display area less than the live streaming room page, on the live streaming room page. Various setting operation controls, such as a control for setting featured products and a control for setting product bundles, are displayed on the object settings page, to perform setting operations on the live streaming object on the live streaming object page.

In order to facilitate understanding of the abovementioned implementations, an embodiment of the present disclosure provides a schematic diagram of an object settings page. When a trigger operation for the object settings control 205 in FIG. 2b is received, an object settings page 501 is displayed on the live streaming object page in the form of a half screen, a seven-tenths screen, etc. The object settings page includes a plurality of setting operation controls, one of which can be tapped to trigger the setting of the live streaming object.

In another optional implementation, in order to facilitate the user hosting the live stream in learning of a live streaming operational status of the current live streaming room in a timely manner, a live streaming data display region may be provided on the live streaming object page. Live streaming operational data on a plurality of statistical dimensions is displayed in the live streaming data display region, so that the user hosting the live stream can learn of the live streaming operational status during live streaming in a timely manner. In this way, the live streaming strategy can be adjusted in a timely manner, thereby improving the viewing experience of the user in the live streaming room.

A live streaming data display region 206 is provided on the live streaming object page shown in FIG. 2b. The live streaming operational data on a plurality of statistical dimensions, such as a sales volume and an average number of online viewers in the current live streaming room, is displayed in the live streaming data display region 206. The live streaming operational data is used to reflect the live streaming operational status of the current live streaming room.

In an optional implementation, statistical data of different dimensions displayed in the live streaming data display region may be operational data of the current live streaming room that is obtained in real time, and the operational data of the current live streaming room that is obtained at different moments is different. In addition, a change status of the live streaming operational data at different moments may also be displayed in the live streaming data display region.

In an actual situation, different users hosting the live stream have different live streaming capabilities, and the numbers of users watching the live stream in respective live streaming rooms are also different. Therefore, when the live streaming operational data is displayed, different live streaming operational data display policies may be set for different live streamers.

In an optional implementation, for a user hosting a live stream that has a strong live streaming capability, that is, has a large number of users watching the live stream, the live streaming operational data may be updated and displayed frequently, for example, every 5 minutes. For a user hosting a live stream that has a small number of users watching the live stream, a display strategy in which the live streaming operational data is updated and displayed based on a longer time period may be set.

In this embodiment of the present disclosure, at least one live streaming object is displayed on the live streaming object page, where the at least one live streaming object is individually provided with the corresponding object management control; and then, the management function list is displayed on the live streaming object page in response to the trigger operation for the target object management control, where at least one management function control is displayed in the management function list, and the management function control is configured to trigger the execution of the corresponding management operation on the live streaming object corresponding to the target object management control. It can be learned that, according to the embodiments of the present disclosure, the execution of the management operation on the live streaming object on the live streaming object page is triggered through the object management control for the live streaming object, so that the live streaming object can be conveniently managed, an operating path is shortened, and the live streaming experience of the user hosting the live stream is improved.

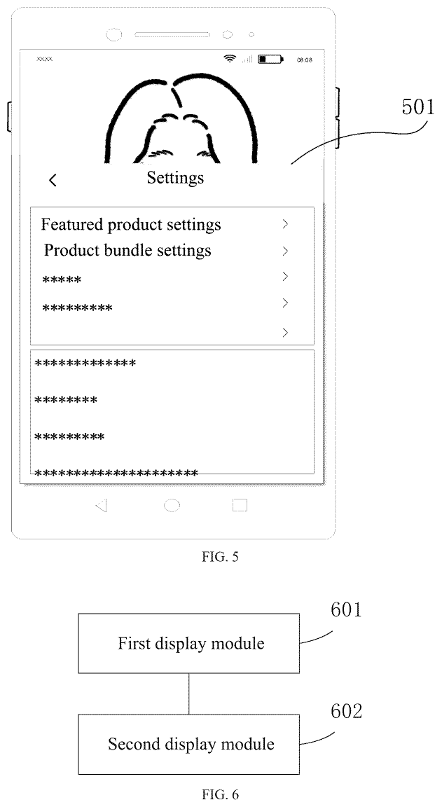

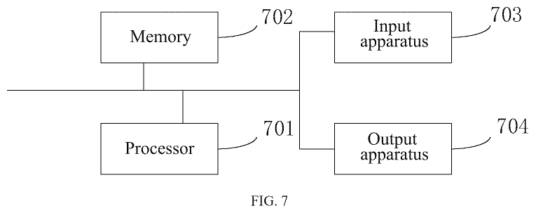

Based on the abovementioned method embodiment, the present disclosure further provides a live streaming processing apparatus. FIG. 6 is a schematic structural diagram of a live streaming processing apparatus according to an embodiment of the present disclosure. The apparatus includes:
a first display module 601 configured to display at least one live streaming object on a live streaming object page, where the at least one live streaming object is individually provided with a corresponding object management control; and
a second display module 602 configured to display a management function list on the live streaming object page in response to a trigger operation for a target object management control, where at least one management function control is displayed in the management function list, and the management function control is configured to trigger the execution of a corresponding management operation on a live streaming object corresponding to the target object management control.

In an optional implementation, before displaying the at least one live streaming object on the live streaming object page, the apparatus further includes:
a first display sub-module configured to display the live streaming object page on a live streaming room page in response to a preset trigger operation performed on the live streaming room page, where the live streaming room page is configured to display a live streaming image, and a display area of the live streaming room page is greater than a display area of the live streaming object page.

In an optional implementation, an object addition control is provided on the live streaming object page, and the apparatus further includes:
a second display sub-module configured to display an object addition page on the live streaming room page in response to a trigger operation for the object addition control, where a plurality of candidate live streaming objects are displayed on the object addition page, the plurality of candidate live streaming objects belong to a set of candidate live streaming objects corresponding to the live streaming room page, and a display area of the object addition page is less than the display area of the live streaming room page.

In an optional implementation, the plurality of candidate live streaming objects are individually provided with an addition management control, and after the object addition page is displayed on the live streaming room page in response to a trigger operation for the object addition control, the following is further included:
determining a candidate live streaming object corresponding to a target addition management control on the object addition page as a live streaming object on the live streaming object page in response to a preset trigger operation for the target addition management control.

In an optional implementation, at least one sorting tag is provided on the live streaming object page, and the apparatus further includes:
a sort module configured to sort live streaming objects on the live streaming object page based on sorting indicator data corresponding to a target sorting tag in the at least one sorting tag in response to a trigger operation for the target sorting tag, to obtain a list of sorted live streaming objects, where the sorting indicator data is determined based on interaction data of the live streaming objects in a current live streaming room; and
an update module configured to update a display order of the live streaming objects on the live streaming object page based on the list of sorted live streaming objects.

In an optional implementation, an object settings control is provided on the live streaming object page, and the apparatus further includes:
a third display module configured to display an object settings page on the live streaming room page in response to a trigger operation for the object settings control, where the object settings page is configured to perform a setting operation on the live streaming object on the live streaming object page, and a display area of the object settings page is less than the display area of the live streaming room page.

In an optional implementation, live streaming operational data on a plurality of statistical dimensions is displayed in a live streaming data display region of the live streaming object page, and the live streaming operational data is used to reflect a live streaming operational status of a current live streaming room.

In an optional implementation, the apparatus is used in a live streamer client.

In the live streaming processing apparatus provided in this embodiment of the present disclosure, first, at least one live streaming object is displayed on a live streaming object page, where the at least one live streaming object is individually provided with a corresponding object management control; and then, a management function list is displayed on the live streaming object page in response to a trigger operation for a target object management control, where at least one management function control is displayed in the management function list, and the management function control is configured to trigger the execution of a corresponding management operation on a live streaming object corresponding to the target object management control. It can be learned that, according to the embodiments of the present disclosure, the management function list and the management function control are displayed by triggering the object management control for the live streaming object on the live streaming object page, so that the management operation on the live streaming object is implemented, thereby diversifying live streaming functions, and improving user experience.

In addition to the method and apparatus described above, an embodiment of the present disclosure further provides a non-transitory computer-readable storage medium having instructions stored therein. The instructions, when executed on a terminal device, cause the terminal device to implement the live streaming processing method described in the embodiments of the present disclosure.

An embodiment of the present disclosure further provides a computer program product. The computer program product includes a computer program or instructions. When the computer program or instructions, when executed by a processor, implement the live streaming processing method described in the embodiments of the present disclosure.

In addition, an embodiment of the present disclosure further provides a live streaming processing device. As shown in FIG. 7, the device may include:
a processor 701, a memory 702, an input apparatus 703, and an output apparatus 704. There may be one or more processors 701 in the data processing device. For example, there is one processor in FIG. 7. In some embodiments of the present disclosure, the processor 701, the memory 702, the input apparatus 703, and the output apparatus 704 may be connected through a bus or in another manner, for example, are connected through the bus in FIG. 7.

The memory 702 may be configured to store a software program and a module. The processor 701 performs various functional applications of the data processing device and processes data by running the software program and the module stored in the memory 702. The memory 702 may mainly include a program storage area and a data storage area. The program storage area may store an operating system, an application required by at least one function, etc. In addition, the memory 702 may include a high-speed random access memory, and may further include a non-volatile memory, for example, at least one magnetic disk storage device, a flash memory device, or another volatile solid-state storage device. The input apparatus 703 may be configured to receive input digital or character information, and generate a signal input related to user settings and function control of the data processing device.

Specifically, in this embodiment, the processor 701 may load an executable file corresponding to processes of one or more applications into the memory 702 according to the following instructions, and the processor 701 runs the applications stored in the memory 702, to implement various functions of the abovementioned live streaming processing device.

It should be noted that the relational terms such as “first” and “second” herein are only used to distinguish one entity or operation from another, and do not necessarily require or imply that any actual relationship or sequence exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

1. A live streaming processing method, comprising:
displaying at least one live streaming object on a live streaming object page, wherein the at least one live streaming object is individually provided with a corresponding object management control; and
displaying a management function list on the live streaming object page in response to a trigger operation for a target object management control, wherein at least one management function control is displayed in the management function list, and the management function control is configured to trigger an execution of a corresponding management operation on a live streaming object corresponding to the target object management control.

2. The method according to claim 1, further comprising: before displaying the at least one live streaming object on the live streaming object page,
displaying the live streaming object page on a live streaming room page in response to a preset trigger operation performed on the live streaming room page, wherein the live streaming room page is configured to display a live streaming image, and a display area of the live streaming room page is greater than a display area of the live streaming object page.

3. The method according to claim 2, wherein an object addition control is provided on the live streaming object page, and the method further comprises:
displaying an object addition page on the live streaming room page in response to a trigger operation for the object addition control, wherein a plurality of candidate live streaming objects are displayed on the object addition page, the plurality of candidate live streaming objects belong to a set of candidate live streaming objects corresponding to the live streaming room page, and a display area of the object addition page is less than the display area of the live streaming room page.

4. The method according to claim 3, wherein the plurality of candidate live streaming objects are individually provided with an addition management control, and the method further comprises: after displaying the object addition page on the live streaming room page in response to the trigger operation for the object addition control,
determining a candidate live streaming object corresponding to a target addition management control on the object addition page as a live streaming object on the live streaming object page in response to a preset trigger operation for the target addition management control.

5. The method according to claim 2, wherein at least one sorting tag is provided on the live streaming object page, and the method further comprises:
sorting live streaming objects on the live streaming object page based on sorting indicator data corresponding to a target sorting tag of the at least one sorting tag, in response to a trigger operation for the target sorting tag, to obtain a list of sorted live streaming objects, wherein the sorting indicator data is determined based on interaction data of the live streaming objects in a current live streaming room; and
updating a display order of the live streaming objects on the live streaming object page based on the list of sorted live streaming objects.

6. The method according to claim 2, wherein an object settings control is provided on the live streaming object page, and the method further comprises:
displaying an object settings page on the live streaming room page in response to a trigger operation for the object settings control, wherein the object settings page is configured to perform a setting operation on the live streaming object on the live streaming object page, and a display area of the object settings page is less than the display area of the live streaming room page.

7. The method according to claim 1, wherein live streaming operational data on a plurality of statistical dimensions is displayed in a live streaming data display region of the live streaming object page, and the live streaming operational data is used to reflect a live streaming operational status of a current live streaming room; and/or
the method is applied to a live streamer client.

8. (canceled)

9. A non-transitory computer-readable storage medium having instructions stored thereon, wherein the instructions, when executed on a terminal device, cause the terminal device to:
display at least one live streaming object on a live streaming object page, wherein the at least one live streaming object is individually provided with a corresponding object management control; and
display a management function list on the live streaming object page in response to a trigger operation for a target object management control, wherein at least one management function control is displayed in the management function list, and the management function control is configured to trigger an execution of a corresponding management operation on a live streaming object corresponding to the target object management control.

10. A live streaming processing device, comprising: a memory, a processor, and a computer program stored on the memory and executable by the processor, wherein the computer program, when executes executed by the processor, causes the device to:
display at least one live streaming object on a live streaming object page, wherein the at least one live streaming object is individually provided with a corresponding object management control; and
display a management function list on the live streaming object page in response to a trigger operation for a target object management control, wherein at least one management function control is displayed in the management function list, and the management function control is configured to trigger an execution of a corresponding management operation on a live streaming object corresponding to the target object management control.

11. The non-transitory computer-readable storage medium according to claim 9, wherein the instructions further cause the terminal device to before displaying the at least one live streaming object on the live streaming object page,
display the live streaming object page on a live streaming room page in response to a preset trigger operation performed on the live streaming room page, wherein the live streaming room page is configured to display a live streaming image, and a display area of the live streaming room page is greater than a display area of the live streaming object page.

12. The non-transitory computer-readable storage medium according to claim 11, wherein an object addition control is provided on the live streaming object page, and the instructions further cause the terminal device to:
display an object addition page on the live streaming room page in response to a trigger operation for the object addition control, wherein a plurality of candidate live streaming objects are displayed on the object addition page, the plurality of candidate live streaming objects belong to a set of candidate live streaming objects corresponding to the live streaming room page, and a display area of the object addition page is less than the display area of the live streaming room page.

13. The non-transitory computer-readable storage medium according to claim 12, wherein the plurality of candidate live streaming objects are individually provided with an addition management control, and the instructions further cause the terminal device to, after displaying the object addition page on the live streaming room page in response to the trigger operation for the object addition control,
determine a candidate live streaming object corresponding to a target addition management control on the object addition page as a live streaming object on the live streaming object page in response to a preset trigger operation for the target addition management control.

14. The non-transitory computer-readable storage medium according to claim 11, wherein at least one sorting tag is provided on the live streaming object page, and the instructions further cause the terminal device to:
sort live streaming objects on the live streaming object page based on sorting indicator data corresponding to a target sorting tag of the at least one sorting tag, in response to a trigger operation for the target sorting tag, to obtain a list of sorted live streaming objects, wherein the sorting indicator data is determined based on interaction data of the live streaming objects in a current live streaming room; and
update a display order of the live streaming objects on the live streaming object page based on the list of sorted live streaming objects.

15. The non-transitory computer-readable storage medium according to claim 11, wherein an object settings control is provided on the live streaming object page, and the instructions further cause the terminal device to:
display an object settings page on the live streaming room page in response to a trigger operation for the object settings control, wherein the object settings page is configured to perform a setting operation on the live streaming object on the live streaming object page, and a display area of the object settings page is less than the display area of the live streaming room page.

16. The non-transitory computer-readable storage medium according to claim 9, wherein live streaming operational data on a plurality of statistical dimensions is displayed in a live streaming data display region of the live streaming object page, and the live streaming operational data is used to reflect a live streaming operational status of a current live streaming room; and/or
the non-transitory computer-readable storage medium is applied to a live streamer client.

17. The device according to claim 10, wherein the computer program further causes the device to before displaying the at least one live streaming object on the live streaming object page,
display the live streaming object page on a live streaming room page in response to a preset trigger operation performed on the live streaming room page, wherein the live streaming room page is configured to display a live streaming image, and a display area of the live streaming room page is greater than a display area of the live streaming object page.

18. The device according to claim 17, wherein an object addition control is provided on the live streaming object page, and the computer program further causes the device to:
display an object addition page on the live streaming room page in response to a trigger operation for the object addition control, wherein a plurality of candidate live streaming objects are displayed on the object addition page, the plurality of candidate live streaming objects belong to a set of candidate live streaming objects corresponding to the live streaming room page, and a display area of the object addition page is less than the display area of the live streaming room page.

19. The device according to claim 18, wherein the plurality of candidate live streaming objects are individually provided with an addition management control, and the computer program further causes the device to, after displaying the object addition page on the live streaming room page in response to the trigger operation for the object addition control,
determine a candidate live streaming object corresponding to a target addition management control on the object addition page as a live streaming object on the live streaming object page in response to a preset trigger operation for the target addition management control.

20. The device according to claim 17, wherein at least one sorting tag is provided on the live streaming object page, and the computer program further causes the device to:
sort live streaming objects on the live streaming object page based on sorting indicator data corresponding to a target sorting tag of the at least one sorting tag, in response to a trigger operation for the target sorting tag, to obtain a list of sorted live streaming objects, wherein the sorting indicator data is determined based on interaction data of the live streaming objects in a current live streaming room; and
update a display order of the live streaming objects on the live streaming object page based on the list of sorted live streaming objects.

21. The device according to claim 17, wherein an object settings control is provided on the live streaming object page, and the computer program further causes the device to:
display an object settings page on the live streaming room page in response to a trigger operation for the object settings control, wherein the object settings page is configured to perform a setting operation on the live streaming object on the live streaming object page, and a display area of the object settings page is less than the display area of the live streaming room page.
